(19) United States
(12) Patent Application Publication
(10) Pub. No.: US 2022/0101074 A1
(43) Pub. Date: Mar. 31, 2022

(54) DEVICE AND METHOD FOR TRAINING A NORMALIZING FLOW USING SELF-NORMALIZED GRADIENTS

(71) Applicant: Robert Bosch GmbH, Stuttgart (DE)

(72) Inventors: Jorn Peters, Amsterdam (NL); Thomas Andy Keller, Amsterdam (NL); Anna Khoreva, Stuttgart (DE); Emiel Hoogeboom, Amsterdam (NL); Max Welling, Amsterdam (NL); Patrick Forre, Amsterdam (NL); Priyank Jaini, Amsterdam (NL)

(21) Appl. No.: 17/448,126

(22) Filed: Sep. 20, 2021

(30) Foreign Application Priority Data
Sep. 29, 2020 (EP) 20199040.5

(51) Int. Cl. G06K 9/66; G06K 9/62; G06F 17/16

(52) U.S. Cl. CPC G06K 9/66; G06K 9/6256; G06K 2009/6237; G06K 9/6277; G06F 17/16; G06K 9/6235

(57) ABSTRACT

A computer-implemented method for training a normalizing flow. The normalizing flow is configured to determine a first output signal characterizing a likelihood or a log-likelihood of an input signal. The normalizing flow includes at least one first layer which includes trainable parameters. A layer input to the first layer is based on the input signal and the first output signal is based on a layer output of the first layer. The training includes: determining at least one training input signal; determining a training output signal for each training input signal using the normalizing flow; determining a first loss value which is based on a likelihood or a log-likelihood of the at least one determined training output signal with respect to a predefined probability distribution; determining an approximation of a gradient of the trainable parameters; updating the trainable parameters of the first layer based on the approximation of the gradient.

### CROSS REFERENCE

The present application claims the benefit under 35 U.S.C. § 119 of European Patent Application No. EP 20199040.5 filed on Sep. 29, 2020, which is expressly incorporated herein by reference in its entirety.

### FIELD

The present invention concerns a method for training a normalizing flow, a method for using the normalizing flow, a classifier, a training system, a computer program and a machine-readable storage medium.

### BACKGROUND INFORMATION

Diederik P. Kingma, Prafulla Dhariwal, “Glow: Generative Flow with Invertible 1×1 Convolutions,” https://arxiv.org/abs/1807.03039v2, Jul. 10, 2018 describe a method for determining a log-likelihood of a datum by means of a normalizing flow.

### SUMMARY

Many modern devices are equipped with technical measures for sensing an internal state of the respective device and/or a state of an environment of the device. This typically causes an abundance of data being generated from the device.

Finding a way to automatically sift through this data gives rise to multiple technical problems. One of these problems is finding a method for determining if or to what degree a given datum characterizing an internal state or a state of an environment is important.

One way of determining an importance of a datum is to determine a data log-likelihood of the datum with respect to, e.g., some previously recorded data. In other words, the importance of the datum can be measured by determining how likely it is to observe the datum given the previously recorded data. For example, one could record a dataset of internal states of a machine (e.g., drawn current, heat, pressure) during normal operation of the machine. If during further operation of the machine an internal state is sensed that has a low log-likelihood with respect to the dataset, this may indicate a malfunction of the machine or an otherwise non-normal behavior of the machine.

It can also be crucial for classifiers to determine a log-likelihood. For example, a Bayesian classifier determines a probability p(y|x) of a class y for a datum x according to the formula

$$p ( y \vert x ) = \frac{p ( y ) p ( x \vert y )}{p ( x )} ,$$

wherein p(y) is a prior probability of the class, p(x) is a data log-likelihood of x and p(x|y) is a class-conditional log-likelihood, i.e., the likelihood of observing the datum for the class. As can be seen from the formulation, a Bayesian classifier needs to determine two likelihood values, i.e., the class-conditional likelihood and the data log-likelihood. A classification accuracy of the Bayesian classifier crucially depends on the ability to correctly determine both likelihood values.

Determining an accurate likelihood or log-likelihood of a datum is hence an important technical problem arising in different technical fields and for different technical tasks.

Especially when having to determine a likelihood for high-dimensional data, e.g., images or audio signals, normalizing flows have shown themselves to be best-suited for determining the likelihood. A normalizing flow can be understood as a neural network from the field of machine learning. The normalizing flow is able to map a first distribution of a datum to a second distribution, wherein the second distribution can be chosen by a user. The advantage of a normalizing flow lies in the fact that the second distribution can be chosen almost arbitrarily. It can especially be chosen such that determining a likelihood of the second distribution can be achieved efficiently and in closed form. From this likelihood, the likelihood of the datum with respect to the first distribution can easily be determined. Hence, the likelihood of the datum can be easily and efficiently computed even if the first distribution is difficult and/or cannot be evaluated in closed form. Instead of the likelihood, the normalizing flow may also determine a log-likelihood.

A normalizing flow is invertible, i.e., a normalizing flow is capable of mapping a given datum to a latent representation and is also capable to map from the latent representation back to the datum.

Being invertible comes with the drawback that training a normalizing flow requires an inversion of a matrix of weights for each layer of the normalizing comprising weights, wherein each matrix is typically comparably large. As the computational complexity of a matrix inversion is generally cubical, the common approach in normalizing flows is to construct the respective weight matrices such that they are triangular as this reduces the computational complexity of the inversion of the matrices to be quadratic. However, designing a normalizing flow this way, i.e., constraining the weight matrices to be triangular, severely restricts the normalizing flow in learning a suitable mapping from the first distribution to the second distributions as it severely restricts the degrees of freedom of the mapping.

It is hence desirable to obtain a normalizing flow that is not restricted to having to comprise triangular weight matrices, wherein the computational complexity of training the normalizing flow is quadratic. In the following, a normalizing flow not restricted to triangular weight matrices will be referred to as unrestricted normalizing flow.

A method in accordance with example embodiments of the present invention allows for training an unrestricted normalizing flow, wherein the computational complexity of training the normalizing flow is quadratic. The method advantageously achieves this by efficiently approximating the matrix inversions necessary during training of the normalizing flow.

With respect to common normalizing flows, training the normalizing flow this way leads to not having to restrict the normalizing flow with respect to the weight layers, which leads to a more powerful mapping function and hence improves the ability of the normalizing flow to accurately determine a likelihood or log-likelihood. The ability of the normalizing flow to accurately determine the likelihood or log-likelihood may also be referred to as performance of the normalizing flow in the following.

Compared to simply training an unrestricted normalizing flow with standard gradient decent methods, training an unrestricted normalizing flow with the method with the features of the present invention leads to a reduction in computational complexity from cubical to quadratic. Given a same amount of training time, this reduction in computational complexity leads to the unrestricted normalizing flow being able to be trained with more training data and hence the unrestricted normalizing flow being able to extract more information during training. In turn, this advantageously leads to an increase in performance of the unrestricted normalizing flow.

In a first aspect, the present invention is concerned with a computer-implemented method for training a normalizing flow, wherein the normalizing flow is configured to determine a first output signal characterizing a likelihood or a log-likelihood of an input signal, wherein the normalizing flow comprises at least one first layer, wherein the first layer comprises trainable parameters and a layer input to the first layer is based on the input signal and the first output signal is based on a layer output of the first layer. In accordance with an example embodiment of the present invention, training the normalizing flow comprises the following steps:
Determining at least one training input signal;
Determining a training output signal for each training input signal by means of the normalizing flow;
Determining a first loss value, wherein the first loss value is based on a likelihood or a log-likelihood of the at least one determined training output signal with respect to a predefined probability distribution;
Determining an approximation of a gradient of the trainable parameters of the first layer with respect to the first loss value, wherein the gradient is dependent on an inverse of a matrix of the trainable parameters and determining the approximation of the gradient is achieved by optimizing an approximation of the inverse;
Updating the trainable parameters of the first layer based on the approximation of the gradient.

A normalizing flow can be understood as a neural network from the field of machine learning. The normalizing flow is able to map a first distribution of a datum to a second distribution, which can be chosen by a user. Preferably, a multivariate normal distribution with an identity matrix as covariance matrix is chosen as second distribution.

A normalizing flow may comprise a plurality layers, wherein a flow of information defines an order of the layers. If the first layer provides an output, i.e., the layer output, to a second layer, the first layer can be considered to precede the second layer while the second layer follows the first layer.

The input signal may be understood as a datum that is provided to the normalizing flow. The input signal may be used as an input of a layer of the normalizing flow, i.e., a layer input. A layer receiving the input signal as layer input may also be referred to as an input layer of the normalizing flow. Similarly, a layer output of a layer may be used as the output signal of the normalizing flow. Such a layer may be referred to as an output layer of the normalizing flow. If a layer comprised in the normalizing flow is neither an input layer nor an output layer, it can be understood as a hidden layer.

The output signal determined from the normalizing flow for the input signal may also be understood as characterizing a classification of importance of the input signal. If the likelihood or log-likelihood characterized by the output signal is high, the input signal may be understood as “not important” with respect to the data the normalizing flow has been trained with, i.e., the input signal is rather similar to at least one training input signal used for training the normalizing flow. Likewise, the input signal may be understood as “important” if the likelihood or log-likelihood characterized by the output signal is low, i.e., the input signal is rather different from the training input signals used for training the normalizing flow. Determining, whether a likelihood or log-likelihood is either low or high, can be achieved by comparing the likelihood or log-likelihood to a predefined threshold. For example, if the likelihood or log-likelihood is below the predefined threshold, the input signal may be classified as “important”. If the likelihood or log-likelihood is equal to the predefined threshold or above the predefined threshold, the input signal may be classified as “not important”.

The first layer may be understood as a weight layer. A weight layer may be understood as comprising a plurality of weights, wherein a layer output of the weight layer is determined based on the plurality of weights and the weights can be adapted during training of the normalizing flow. Typical forms of weight layers are fully connected layers or convolutional layers.

An input signal may comprise at least one image, especially an image as recorded by a sensor, e.g., a camera sensor, a LIDAR sensor, a radar sensor, an ultrasonic sensor or a thermal camera. The image may also be generated artificially, e.g., by means of a rendering of a computer simulation, a rendering of a virtual scene created in a computer, a machine learning system that generates the image or by digitally drawing the image. Alternatively or additionally, the input signal may comprise at least one audio signal, e.g., as recorded from a microphone. The audio signal may also be generated artificially, e.g., from a computer simulation, a machine learning system that generates the audio signal or by digitally composing the audio signal. The audio signal may, for example, characterize a recording of speech. Alternatively, the audio signal may characterize a recording of audio events, e.g., sirens, alarms or other auditory notification signals.

The training input signal may be determined by selecting an input signal from a computer-implemented database of input signals. Alternatively, the input signal may also be determined from a sensor, preferably during operation of the sensor or during operation of a device that comprises the sensor.

The training output signal may then be determined by forwarding the training input signal through the normalizing flow, i.e., through the layers of the normalizing flow.

The training output signal may be in the form of a vector. If it is in the form of a tensor, it may be reshaped to a vector.

Preferably, the first loss value is determined by determining a negative log-likelihood of the output signal with respect to the second probability distribution. Updating the trainable parameters of the first layer may then be achieved by means of a gradient descent algorithm.

The normalizing flow may also be configured to accept a plurality of input signals, i.e., a batch of input signals, wherein for each input signal from the plurality of input signals a corresponding output signal characterizing a likelihood or a log-likelihood of the respective input signal is determined by the normalizing flow.

Likewise, the normalizing flow may preferably be trained with a plurality of training input signals. Preferably, a training output signal is determined for each training input signal from the plurality of training input signals and for each training output signal a likelihood or log-likelihood of the respective output signal with respect to the predefined distribution is determined. Based on this determined plurality likelihoods or log-likelihoods, the first loss value may then preferably be determined by averaging or summing the likelihoods or log-likelihoods.

If a single training input signal is used for training, the first loss value may be the likelihood or log-likelihood determined for an output signal of the normalizing flow for the single training input signal.

It may also be provided that the approximation of the inverse is optimized based on the at least one training input signal.

An advantage of this is that the inverse can be determined based on a limited amount of training input signals during training. This substantially speeds up the training. Given equal resources, i.e., the same amount of time, the approach hence increases the performance of the normalizing flow as the normalizing flow can be trained with more training input signals.

It can also be provided that the first layer is a fully connected layer and the layer output is determined according to the formula

zₗ=σ(hₗ)=σ(Wₗzₗ₋₁), wherein zₗ is the layer output of the first layer, σ is an invertible activation function of the first layer and hₗ is the result of a matrix multiplication of a matrix Wₗ comprising the trainable parameters of the first layer and the layer input zₗ₋₁.

An advantage of this approach is that a fully connected layer can be used in the normalizing flow which allows for enabling more degrees of freedom of the mapping represented by the normalizing flow. As described above, this leads to an increase in performance of the normalizing flow.

It can be further provided that, the approximation of the gradient of the matrix Wₗ can be determined according to the formula

$${∇}_{{W}_{l}} = \frac{\partial {p}_{X} ( {x}_{i} )}{\partial {h}_{l}} {z}_{l - 1}^{T} + {R}_{l}^{T} ,$$

wherein

$$\frac{\partial {p}_{X} ( {x}_{i} )}{\partial {h}_{l}}$$

is a partial derivative of the first loss value with respect to the result of the matrix multiplication, the superscript T denotes transposing a matrix or a vector, xᵢ is the training input signal and Rₗ is the approximation of the inverse of the matrix Wₗ.

p_{X}(xᵢ) may be understood as a likelihood or log-likelihood of the training input signal xᵢ, e.g., the standard formulation of the likelihood or log-likelihood used in training normalizing flows.

Determining the approximation of the gradient this way is advantageous as approximating the inverse of the weight matrix leads to a decrease in computational complexity of the training method. This leads to an increase in performance of the normalizing flow as described above.

It can also be provided that Rₗ is determined based on a second loss function

[symbol]

_{recon}^{(l)}=∥RₗWₗzₗ₋₁−zₗ₋₁∥, wherein ∥·∥ is a norm. In particular, the norm may be a squared Euclidean distance. However, other norms are possible as well, e.g., a Euclidean norm, a Manhattan norm or another p-norm.

If a single training input signal is used for training the normalizing flow, Rₗ may be determined by minimizing the second loss function. If a batch of training input signals is used for training, Rₗ may preferably be determined by determining zₗ₋₁ for each training input signal in the batch, determining an output of the second loss function for each determined zₗ₋₁ and minimizing an average or a sum of the outputs with respect to Rₗ.

Determining the gradient this way is advantageous as it does not require an inversion of the matrix Wₗ.

Additionally, the inventors surprisingly found that a sufficient approximation of the inverse of the matrix Wₗ can be found by optimizing Rₗ based on the second loss function using an iterative optimization algorithm, wherein only one optimization step is performed for determining Rₗ. For example, Rₗ may be determined by means of a gradient descent algorithm using only a single step of gradient descent.

An advantage of adapting the trainable parameters of the first layer this way is that the time required for determining the approximation of the gradient is greatly reduced, which in turn leads to a speed up in training, all the while enabling Wₗ not having to be triangular. The speed up in training time leads to an increase in performance of the normalizing flow as described above.

It can also be provided that the first layer is a convolutional layer and the layer output is determined according to the formula

Zₗ=σ(Hₗ)=(Wₗ*Zₗ₋₁₎, wherein Zₗ is the layer output of the first layer, σ is an invertible activation function of the first layer, Hₗ is the result of a discrete convolution of a tensor Wₗ and the layer input Zₗ₋₁, wherein the tensor Wₗ comprises the trainable parameters of the first layer and * denotes a discrete convolution operation.

This is advantageous as convolutional layers increase the performance of the normalizing flow for input signals comprising images.

It can be further provided that the gradient of the first loss value with respect to the trainable parameters of the first layer can then be determined according to the formula

$${∇}_{{W}_{l}} = \frac{\partial {p}_{X} ( {x}_{i} )}{\partial {h}_{l}} {★ Z}_{l - 1} + flip ( {R}_{l} ) ⊙ M ,$$

wherein

$$\frac{\partial {p}_{X} ( {x}_{i} )}{\partial {H}_{l}}$$

is a partial derivative M=ones_like(Zₗ)*ones_like(Zₗ₋₁),
of the first loss value with respect to the result of the discrete convolution, xᵢ is the training input signal, ⊙ denotes an element-wise multiplication operation, ones_like is a function that takes a first tensor as input and returns a second tensor of the same shape as the first tensor, wherein the second tensor is filled with all ones, and Rₗ is a tensor characterizing an approximation of a third tensor, wherein convolving the third tensor with Hₗ yields Zₗ₋₁, and flip is a function that determines a tensor for a transpose convolution.

This is advantageous as the approximation leads to a decrease in computational complexity of the training method. This leads to an increase in performance of the normalizing flow as described above.

The layer input Zₗ₋₁ is preferably given in the form of a three-dimensional tensor, wherein a first dimension corresponds to an amount of channels of the layer input and a second and third dimension corresponds to a height and width of the layer input respectively. If the first layer is an input layer of the normalizing flow, the layer input can, for example, be an RGB image, wherein the number of channels would hence be three.

The tensor Wₗ can be understood as a tensor of kernels as is commonly used for convolutional neural networks. Preferably, the tensor of kernels is a four-dimensional tensor, wherein a first dimension corresponds to the number of filters used in the convolutional layer, i.e., the first layer, a second dimension corresponds to the number of input channels of the layer input Zₗ₋₁ and a third and fourth dimension of the tensor of kernels correspond to the height and width of the kernels respectively.

The result Hₗ of convolving the layer input with the tensor of kernels may preferably be a three-dimensional tensor of feature maps, wherein a first dimension corresponds to the number of feature maps (there exist as many as there are kernels) and a second and third dimension correspond to the height and width of the result respectively.

The third tensor may be understood as allowing for inverting a convolution based on the tensor of kernels Wₗ, i.e., Uₗ*Hₗ=Zₗ₋₁, wherein Uₗ is the third tensor.

The tensor Rₗ is an approximation of the third tensor, wherein Rₗ may preferably be obtained based on a second loss function [symbol] _{recon}^{(l)}=∥Rₗ*Wₗ*Zₗ₋₁−Zₗ₋₁∥, wherein ∥·∥ is a norm.

In particular, the norm may be a squared Euclidean distance. However, other norms are possible as well, e.g., a Euclidean norm, a Manhattan norm or another p-norm.

If a single training input signal is used for training the normalizing flow, Rₗ may be determined by minimizing the second loss function with respect to Rₗ. If a batch of training input signals is used for training, Rₗ may preferably be determined by determining Zₗ₋₁ for each training input signal in the batch, determining an output of the second loss function for each determined Zₗ₋₁ and minimizing an average or a sum of the outputs with respect to Rₗ.

Determining the gradient this way is advantageous as it does not require an inversion of a matrix based on the tensor Wₗ. For determining the gradient of the loss value with respect to the trainable parameters of the first layer, a convolution can also be expressed in the form of a matrix multiplication Zₗ=unflatten( [symbol] (Wₗ)·flatten(Zₗ₋₁)), wherein flatten is a function that flattens a tensor, · is a matrix multiplication, [symbol] is a function that transforms the kernels of the tensor of kernels Wₗ into a Toeplitz matrix and unflatten is an inverse function of the flatten function.

Using this notation, one obtains a gradient ∇_{W}_{ₗ} that comprises a term [symbol] (Wₗ)⁻¹, i.e., an inversion of a matrix based on the tensor of kernels Wₗ. Determining and using the tensor Rₗ as shown above hence removes the need for a matrix inversion. This in turn reduces the training time, leading to the advantages as already discussed above.

The result of flip(Rₗ) corresponds to the tensor of kernels which achieves the transpose convolution (Rₗ)^{T}, and is given explicitly by swapping the input and output channels of the tensor Rₗ and mirroring the filter height and filter width (spatial) dimensions of the kernels.

Additionally, the inventors surprisingly found that a sufficient tensor Rₗ can be found by optimizing Rₗ based on the second loss function using an iterative optimization algorithm, wherein only one optimization step is performed for determining Rₗ. For example, Rₗ may be determined by means of a gradient descent algorithm using only a single step of gradient descent.

Irrespective of the type of the first layer, the activation function may be defined as a function of a scalar input, wherein for applying the activation function to a tensor the function is applied to each element of the tensor individually. The activation function σ may preferably be a Leaky-ReLU.

It can be further provided that a device is operated based on the output signal of the normalizing flow.

This is advantageous as the improved performance of the normalizing flow leads directly to a better operation of the device.

For example, it can be provided that the normalizing flow is comprised in a classifier, wherein the classifier is configured to determine a second output signal characterizing a classification of the input signal, wherein the second output signal is determined based on the first output signal.

The classifier may, for example, be an anomaly detector which is configured to classify, whether an input signal characterizes anomalous data or not with respect to, e.g., known normal data. It can be provided that the anomaly detector is configured to compare an output signal obtained for a given input signal to a predefined threshold. This can be understood as determining whether the likelihood or log-likelihood obtained from the normalizing flow indicates the input signal is unlikely with respect to the training data of the normalizing flow.

Alternatively, the classifier may also be a multiclass classifier, preferably a Bayesian classifier that determines a probability p(y|x) of a class y for an input signal x according to the formula

$$p ( y \vert x ) = \frac{p ( y ) p ( x \vert y )}{p ( x )} ,$$

wherein p(y) is a prior probability of the class, p(x) is a data log-likelihood of x and p(x|y) is a class-conditional log-likelihood, i.e., the likelihood of observing the datum for the class. Besides the data log-likelihood, the class-conditional log-likelihood can also be obtained from a normalizing flow. For example, for each class to be classified, a normalizing flow can be trained with data only from this class. During inference, each normalizing flow can then predict a log-likelihood that represents the class-conditional log-likelihood for the class the respective normalizing flow belongs to.

The second output signal of the classifier may characterize a classification of the input signal into at least one class. Alternatively or additionally, the second output signal may also characterize a classification of objects in the input signal and a corresponding location of the objects. For example, the input signal may comprise an image and the second output signal may characterize a classification of an object in the image and the objects location in the image. Alternatively or additionally, the second output signal may also characterize multiple classifications of the input signal, e.g., a semantic segmentation.

Irrespective of the exact form of the classifier comprising the normalizing flow, the improved performance of the normalizing flow advantageously leads to an increase in classification accuracy of the classifier.

When used as part of a classifier, training the normalizing flow may be understood as at least part of training the classifier, i.e., the steps comprised in training the classifier may also be comprised in training the classifier.

Alternatively or additionally, it can be provided that the input signal characterizes an internal state of a device and/or an operation status of the device and/or a state of an environment of the device, wherein the first output signal of the normalizing flow is made available to a user of the device by means of a displaying device.

An advantage of the proposed approach is that the user may be provided insights into the inner workings of the device in a guided human-machine interaction process.

For example, the device may be an at least partially automated machine, e.g., a robot, an at least partially automated manufacturing machine or an at least partially autonomous vehicle, wherein the at least partially automated machine is at least partially operated automatically based on an input signal from a sensor. The input signal may also be provided to the normalizing flow. The output signal may further be displayed on a monitor in a suitable fashion, e.g., to an operator of the machine. If the normalizing flow determines a low log-likelihood for an input signal, this indicates that the input signal from the sensor comprises data which may be understood as unusual, unlikely or even anomalous. It is possible that basing an automatic operation of the machine on such an input signal may lead to an undesired or even unsafe behavior of the machine as the unusual input signal can be expected to not be processed correctly by the machine. Based on the displayed log-likelihood, the operator could hence take over manual control of the machine to avoid a potentially unwanted and/or unsafe behavior of the machine. The normalizing flow would hence enable the user to get a direct insight into the inner workings of the machine, i.e., the importance of the input signals on which the automatic decisions of the machine are based.

Embodiments of the present invention will be discussed with reference to the figures in more detail.

### BRIEF DESCRIPTION OF THE DRAWINGS

FIG. 1 shows a training system for training a normalizing flow, in accordance with an example embodiment of the present invention.

FIG. 2 shows a control system comprising a normalizing controlling an actuator in its environment, in accordance with an example embodiment of the present invention.

FIG. 3 shows the control system controlling an at least partially autonomous robot, in accordance with an example embodiment of the present invention.

FIG. 4 shows the control system controlling a manufacturing machine, in accordance with an example embodiment of the present invention.

FIG. 5 shows the control system controlling an automated personal assistant, in accordance with an example embodiment of the present invention.

FIG. 6 shows the control system controlling an access control system, in accordance with an example embodiment of the present invention.

FIG. 7 shows the control system controlling a surveillance system, in accordance with an example embodiment of the present invention.

FIG. 8 shows the control system controlling an imaging system, in accordance with an example embodiment of the present invention.

### DETAILED DESCRIPTION OF EXAMPLE EMBODIMENTS

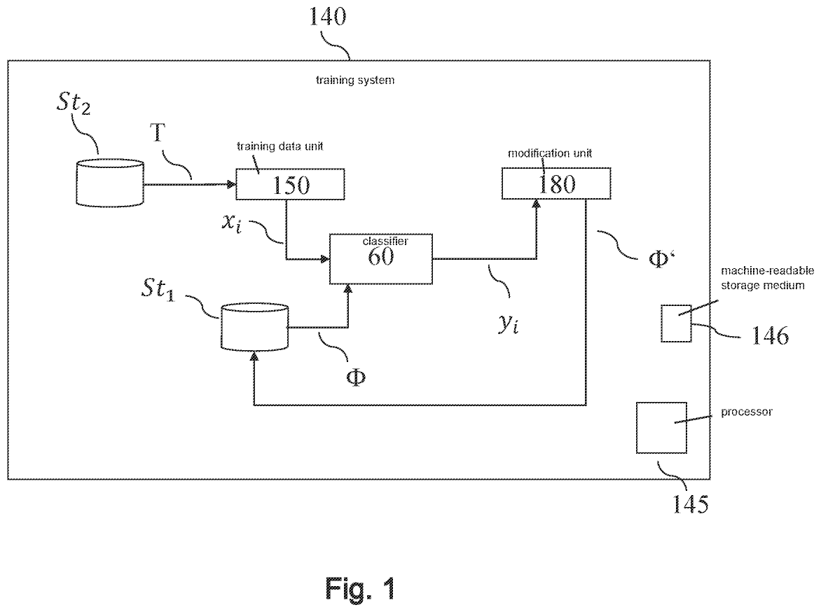

FIG. 1 shows an embodiment of a training system (140) for training a unrestricted normalizing flow (60) by means of a training data set (T). The training data set (T) comprises a plurality of training input signals (xᵢ) which are used for training the classifier (60). The unrestricted normalizing flow may contain a plurality of fully connected layers and/or a plurality of convolutional layers. The normalizing flow is further parametrized by a plurality of parameters comprising the weights of the fully connected layers and/or the weights of the convolutional layers.

For training, a training data unit (150) accesses a computer-implemented database (St₂), where the database (St₂) provides the training data set (T). The training data unit (150) determines from the training data set (T) preferably randomly at least one training input signal (xᵢ) and transmits the training input signal (xᵢ) to the classifier normalizing flow (60). The normalizing flow (60) determines an output signal (yᵢ) based on the input signal (xᵢ). The determined output signal (yᵢ) is preferably given in the form of a vector. In further embodiments, the output signal (yᵢ) may also be given in form of a tensor. In these further embodiments, the determined output signal may be flattened to obtain the determined output signal in the form of a vector.

The determined output signal (yᵢ) is transmitted to a modification unit (180).

Based on the determined output signal (yᵢ), the modification unit (180) then determines new parameters (Φ′) for the classifier (60). For this purpose, the modification unit (180) determined a negative log-likelihood value of the determined output signal (yᵢ) with respect to a second probability distribution. In the embodiment, a multivariate standard normal distribution is chosen. In further embodiments, other probability distributions may be chosen as second probability distribution.

The modification unit (180) determines the new parameters (Φ′) based on the log-likelihood value. In the given embodiment, this is done using a gradient descent method, preferably stochastic gradient descent, Adam, or AdamW. The gradient descent method requires a gradient of the parameters (Φ) with respect to the negative log-likelihood value in order to determine the new parameters (Φ′). For determining the gradient, the negative log-likelihood value is backpropagated through the normalizing flow in order to determine the gradients of the parameters of the layers of the normalizing flow with respect to the negative log-likelihood value.

If a gradient is propagated through a fully connected layer, a gradient of the weights comprised in the fully connected layer is determined according to the formula

$${∇}_{{W}_{l}} = \frac{\partial {p}_{X} ( {x}_{i} )}{\partial {h}_{l}} {z}_{l - 1}^{T} + {R}_{l}^{T} ,$$

wherein

$$\frac{\partial {p}_{X} ( {x}_{i} )}{\partial {h}_{l}}$$

is a partial derivative of the first loss value with respect to the result of a matrix multiplication according to the formula

zₗ=σ(hₗ)=σ(Wₗzₗ₋₁),
wherein z₁ is the layer output of the fully connected layer, σ is an invertible activation function of the fully connected layer and hₗ is the result of a matrix multiplication of a matrix Wₗ comprising the weights of the fully connected layer and the layer input zₗ₋₁ of the fully connected layer.

Furthermore, the superscript T denotes transposing a matrix or a vector, xᵢ is the training input signal and Rₗ is a matrix that is determined by minimizing a second loss function

[symbol]

_{recon}^{(l)}=∥RₗWₗzₗ₋₁−zₗ₋₁∥₂²,
with respect to Rₗ. Preferably, minimizing the second loss function is achieved by a single step of gradient descent on the second loss function. In other words, a single step of gradient descent on the first loss function may preferably include a single step of gradient descent for each fully connected layer on the second loss function.

If a gradient is propagated through a convolutional layer of the normalizing flow, a gradient of the weights comprised in the convolutional layer is determined according to the formula

$${∇}_{{W}_{l}} = \frac{\partial {p}_{X} ( {x}_{i} )}{\partial {H}_{l}} {★Z}_{l - 1} + flip ( {R}_{l} ) ⊙ M ,$$

wherein

$$\frac{\partial {p}_{X} ( {x}_{i} )}{\partial {H}_{l}}$$

is a gradient of the M=ones_like(Zₗ)*ones_like(Zₗ₋₁),
negative log-likelihood value with respect to the result of a discrete convolution
Zₗ=σ(Hₗ)=σ(Wₗ*Zₗ₋₁), wherein Zₗ is the layer output of the convolutional layer, σ is an invertible activation function of the convolutional layer, Hₗ is the result of a discrete convolution of a tensor Wₗ comprising the weights of the convolutional layer and the layer input Zₗ₋₁ and * denotes a discrete convolution operation. Moreover, xᵢ is the training input signal, ⊙ denotes an element-wise multiplication operation, ones_like is a function that takes a first tensor as input and returns a second tensor of the same shape as the first tensor, wherein the second tensor is filled with all ones, flip is a function that determines a tensor for a transpose convolution and Rₗ is a tensor which may be determined by minimizing a second loss function

[symbol]

_{recon}^{(l)}=∥Rₗ*Wₗ*Zₗ₋₁−Zₗ₋₁∥₂²

with respect to Rₗ. Preferably, minimizing the second loss function is achieved by a single step of gradient descent on the second loss function. In other words, a single step of gradient descent on the first loss function may preferably include a single step of gradient descent for each fully connected layer on the second loss function.

In further preferred embodiments, the normalizing flow is trained with a plurality of training input signals (xᵢ) during each step of gradient descent on the first loss function.

Preferably, the gradient descent may be repeated iteratively for a predefined number of iteration steps or repeated iteratively until the negative log-likelihood value is less than a predefined threshold value. Alternatively or additionally, it is also possible that the training is terminated when an average negative log-likelihood value with respect to a test or validation data set falls below a predefined threshold value. In at least one of the iterations the new parameters (Φ′) determined in a previous iteration are used as parameters (Φ) of the normalizing flow (60).

Furthermore, the training system (140) may comprise at least one processor (145) and at least one machine-readable storage medium (146) containing instructions which, when executed by the processor (145), cause the training system (140) to execute a training method according to one of the aspects of the invention.

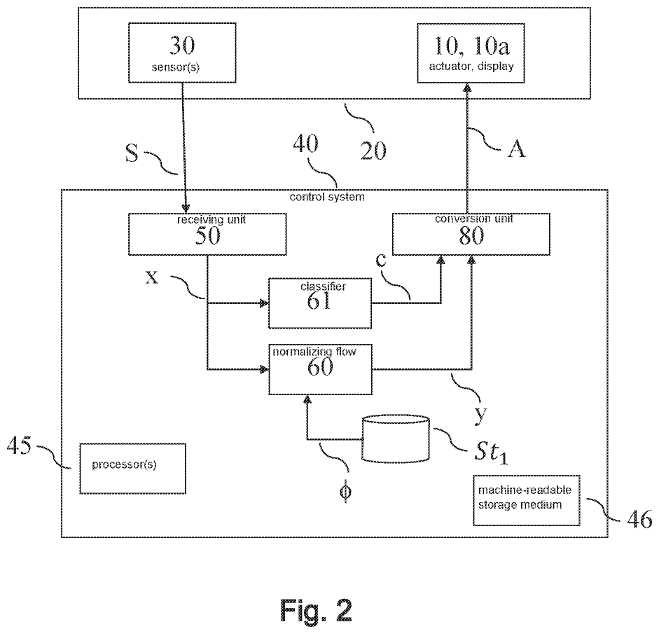

In further embodiments (not shown) the training input signal (xᵢ) may also be provided from a sensor. For example, the training system may be part of a device which is capable to sense its environment by means of a sensor. The input signals obtained from the sensor may be used directly for training the normalizing flow (60). Alternatively, the input signals may be transformed before being provided to the normalizing flow. Shown in FIG. 2 is an embodiment of an actuator (10) in its environment (20) being controlled based on an output signal (y) of the normalizing flow (60) comprised in a control system (40).

At preferably evenly spaced points in time, a sensor (30) senses a condition of the environment (20). The sensor (30) may comprise several sensors. Preferably, the sensor (30) is an optical sensor that takes images of the environment (20). An output signal (S) of the sensor (30) (or, in case the sensor (30) comprises a plurality of sensors, an output signal (S) for each of the sensors) which encodes the sensed condition is transmitted to the control system (40).

Thereby, the control system (40) receives a stream of sensor signals (S). It then computes a series of control signals (A) depending on the stream of sensor signals (S), which are then transmitted to the actuator (10).

The control system (40) receives the stream of sensor signals (S) of the sensor (30) in an optional receiving unit (50). The receiving unit (50) transforms the sensor signals (S) into input signals (x). Alternatively, in case of no receiving unit (50), each sensor signal (S) may directly be taken as an input signal (x). The input signal (x) may, for example, be given as an excerpt from the sensor signal (S). Alternatively, the sensor signal (S) may be processed to yield the input signal (x). In other words, the input signal (x) is provided in accordance with the sensor signal (S).

The input signal (x) is then passed on to the normalizing flow (60) in further preferred embodiments, the input signal (x) may also be passed on to a classifier (61) which is configured to determine a second output signal (c) characterizing a classification of the input signal (x). The second output signal (c) comprises information that assigns one or more labels to the input signal (x). In these further embodiments, the normalizing flow (60) is preferably trained with the training input signals (xᵢ) used for training the classifier (61).

The normalizing flow (60) is parametrized by parameters (□□, which are stored in and provided by a parameter storage (St₁).

The output signal (y) is transmitted to an optional conversion unit (80), which converts the output signal (y) into the control signals (A). If the control system comprises a classifier (61), the second output signal (c) is also transmitted to the optional conversion unit (80) and used for obtaining the control signals (A). The control signals (A) are then transmitted to the actuator (10) for controlling the actuator (10) accordingly. Alternatively, the output signal (y) or the output signal (y) and the second output signal (c) may directly be taken as control signal (A).

The actuator (10) receives control signals (A), is controlled accordingly and carries out an action corresponding to the control signal (A). The actuator (10) may comprise a control logic which transforms the control signal (A) into a further control signal, which is then used to control actuator (10).

In embodiments, the control system (40) may comprise the sensor (30). In even further embodiments, the control system (40) alternatively or additionally may comprise an actuator (10).

In even still further embodiments, it can be provided that the control system (40) controls a display (10a) instead of or in addition to the actuator (10).

In still further embodiments, the classifier (61) may comprise the normalizing flow. The classifier (61) may for example be a Bayesian classifier, wherein the normalizing flow (60) is configured to determine a class-conditional log-likelihood value for a class of the classifier (61).

Furthermore, the control system (40) may comprise at least one processor (45) and at least one machine-readable storage medium (46) on which instructions are stored which, if carried out, cause the control system (40) to carry out a method according to an aspect of the invention.

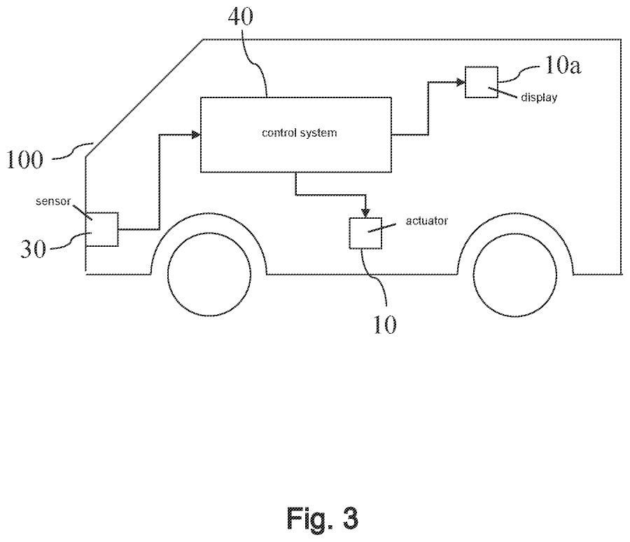

FIG. 3 shows an embodiment in which the control system (40) is used to control an at least partially autonomous robot, e.g., an at least partially autonomous vehicle (100).

The sensor (30) may comprise one or more video sensors and/or one or more radar sensors and/or one or more ultrasonic sensors and/or one or more LiDAR sensors. Some or all of these sensors are preferably but not necessarily integrated in the vehicle (100). The input signal (x) may hence be understood as an input image and the classifier (60) as an image classifier.

The image classifier (60) may be configured to detect objects in the vicinity of the at least partially autonomous robot based on the input image (x). The second output signal (c) may comprise an information, which characterizes where objects are located in the vicinity of the at least partially autonomous robot. The control signal (A) may then be determined in accordance with this information, for example to avoid collisions with the detected objects.

The output signal (y) may characterize a log-likelihood of the input image (x) and is preferably also used for determining the control signal (A). For example, if the output signal (y) characterizes a log-likelihood that is below a predefined threshold an autonomous operation of the vehicle (100) may be aborted and operation of the vehicle may be handed over to a driver of the vehicle (100) or an operator of the vehicle (100).

The actuator (10), which is preferably integrated in the vehicle (100), may be given by a brake, a propulsion system, an engine, a drivetrain, or a steering of the vehicle (100). The control signal (A) may be determined such that the actuator (10) is controlled such that vehicle (100) avoids collisions with the detected objects. The detected objects may also be classified according to what the image classifier (60) deems them most likely to be, e.g., pedestrians or trees, and the control signal (A) may be determined depending on the classification.

Alternatively or additionally, the control signal (A) may also be used to control the display (10a), e.g., for displaying the objects detected by the image classifier (60). It can also be provided that the control signal (A) may control the display (10a) such that it produces a warning signal, if the vehicle (100) is close to colliding with at least one of the detected objects. The warning signal may be a warning sound and/or a haptic signal, e.g., a vibration of a steering wheel of the vehicle.

The display may further provide a visual presentation characterizing the output signal. The driver or operator of the vehicle (100) may hence be informed about the log-likelihood of an input image (x) and may hence gain insight into the inner operations of the vehicle (100).

In further embodiments, the at least partially autonomous robot may be given by another mobile robot (not shown), which may, for example, move by flying, swimming, diving or stepping. The mobile robot may, inter alia, be an at least partially autonomous lawn mower, or an at least partially autonomous cleaning robot. In all of the above embodiments, the control signal (A) may be determined such that propulsion unit and/or steering and/or brake of the mobile robot are controlled such that the mobile robot may avoid collisions with said identified objects.

In even further embodiments, the at least partially autonomous robot may be given by a domestic appliance (not shown), like e.g. a washing machine, a stove, an oven, a microwave, or a dishwasher. The sensor (30), e.g., an optical sensor, may detect a state of an object which is to undergo processing by the household appliance. For example, in the case of the domestic appliance being a washing machine, the sensor (30) may detect a state of the laundry inside the washing machine. The control signal (A) may then be determined depending on a detected material of the laundry.

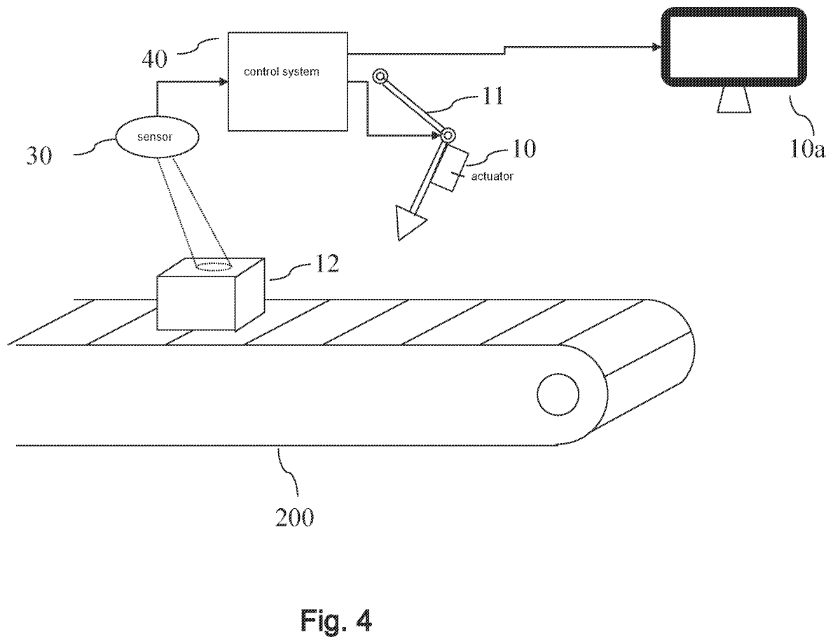

Shown in FIG. 4 is an embodiment in which the control system (40) is used to control a manufacturing machine (11), e.g., a punch cutter, a cutter, a gun drill or a gripper, of an at least partially automated manufacturing system (200), e.g., as part of a production line. The manufacturing machine may comprise a transportation device, e.g., a conveyer belt or an assembly line, which moves a manufactured product (12). The control system (40) controls an actuator (10), which in turn controls the manufacturing machine (11).

The sensor (30) may be given by an optical sensor which captures properties of, e.g., a manufactured product (12). The classifier (60) may hence be understood as an image classifier.

The image classifier (60) may determine a position of the manufactured product (12) with respect to the transportation device. The actuator (10) may then be controlled depending on the determined position of the manufactured product (12) for a subsequent manufacturing step of the manufactured product (12). For example, the actuator (10) may be controlled to cut the manufactured product at a specific location of the manufactured product itself. Alternatively, it may be provided that the image classifier (60) classifies, whether the manufactured product is broken or exhibits a defect. The actuator (10) may then be controlled as to remove the manufactured product from the transportation device.

The log-likelihood characterized by the output signal (y) of the normalizing flow may be displayed on a display (10a) to an operator of the manufacturing system (200). Based on the displayed log-likelihood, the operator may determine to intervene in the automatic manufacturing process of the manufacturing system (200). Alternatively or additionally, automatic operation of the manufacturing machine (200) may be stopped if the log-likelihood value characterized by the output signal (y) is less than a predefined threshold or has been less than the predefined threshold for a predefined amount of time.

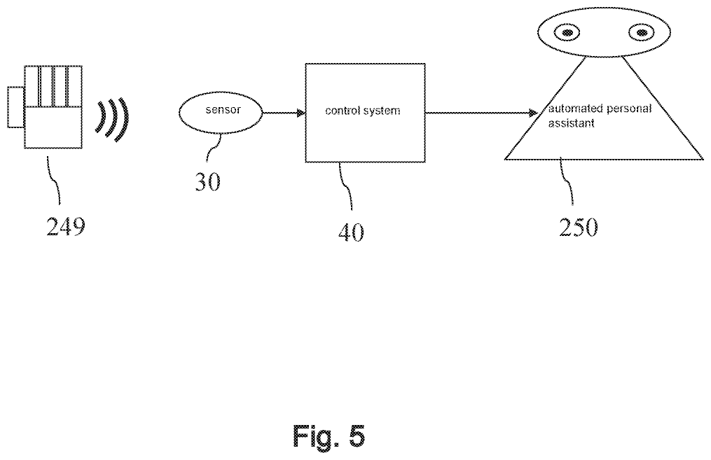

Shown in FIG. 5 is an embodiment in which the control system (40) is used for controlling an automated personal assistant (250). The sensor (30) may be an optic sensor, e.g., for receiving video images of a gestures of a user (249).

Alternatively, the sensor (30) may also be an audio sensor, e.g., for receiving a voice command of the user (249).

The control system (40) then determines control signals (A) for controlling the automated personal assistant (250). The control signals (A) are determined in accordance with the sensor signal (S) of the sensor (30). The sensor signal (S) is transmitted to the control system (40). For example, the classifier (60) may be configured to, e.g., carry out a gesture recognition algorithm to identify a gesture made by the user (249). The control system (40) may then determine a control signal (A) for transmission to the automated personal assistant (250). It then transmits the control signal (A) to the automated personal assistant (250).

For example, the control signal (A) may be determined in accordance with the identified user gesture recognized by the classifier (60). It may comprise information that causes the automated personal assistant (250) to retrieve information from a database and output this retrieved information in a form suitable for reception by the user (249).

In further embodiments, it may be provided that instead of the automated personal assistant (250), the control system (40) controls a domestic appliance (not shown) controlled in accordance with the identified user gesture. The domestic appliance may be a washing machine, a stove, an oven, a microwave or a dishwasher.

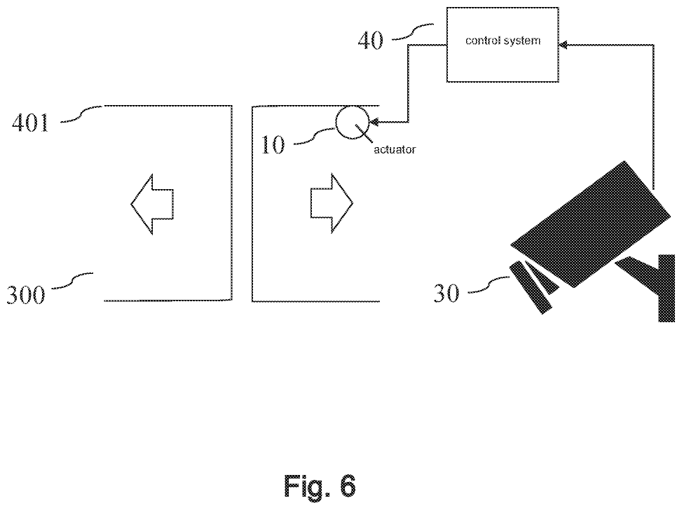

Shown in FIG. 6 is an embodiment in which the control system (40) controls an access control system (300). The access control system (300) may be designed to physically control access. It may, for example, comprise a door (401). The sensor (30) can be configured to detect a scene that is relevant for deciding whether access is to be granted or not. It may, for example, be an optical sensor for providing image or video data, e.g., for detecting a person's face. The classifier (60) may hence be understood as an image classifier.

The image classifier (60) may be configured to classify an identity of the person, e.g., by matching the detected face of the person with other faces of known persons stored in a database, thereby determining an identity of the person. The control signal (A) may then be determined depending on the classification of the image classifier (60), e.g., in accordance with the determined identity. The actuator (10) may be a lock which opens or closes the door depending on the control signal (A). Alternatively, the access control system (300) may be a non-physical, logical access control system. In this case, the control signal may be used to control the display (10a) to show information about the person's identity and/or whether the person is to be given access.

The log-likelihood characterized by the output signal (y) may also be displayed on the display (10a).

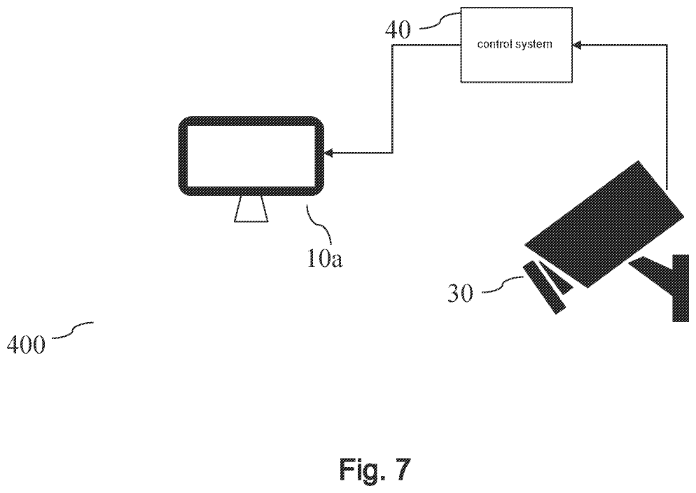

Shown in FIG. 7 is an embodiment in which the control system (40) controls a surveillance system (400). This embodiment is largely identical to the embodiment shown in FIG. 5.

Therefore, only the differing aspects will be described in detail. The sensor (30) is configured to detect a scene that is under surveillance. The control system (40) does not necessarily control an actuator (10), but may alternatively control a display (10a). For example, the image classifier (60) may determine a classification of a scene, e.g., whether the scene detected by an optical sensor (30) is normal or whether the scene exhibits an anomaly. The control signal (A), which is transmitted to the display (10a), may then, for example, be configured to cause the display (10a) to adjust the displayed content dependent on the determined classification, e.g., to highlight an object that is deemed anomalous by the image classifier (60).

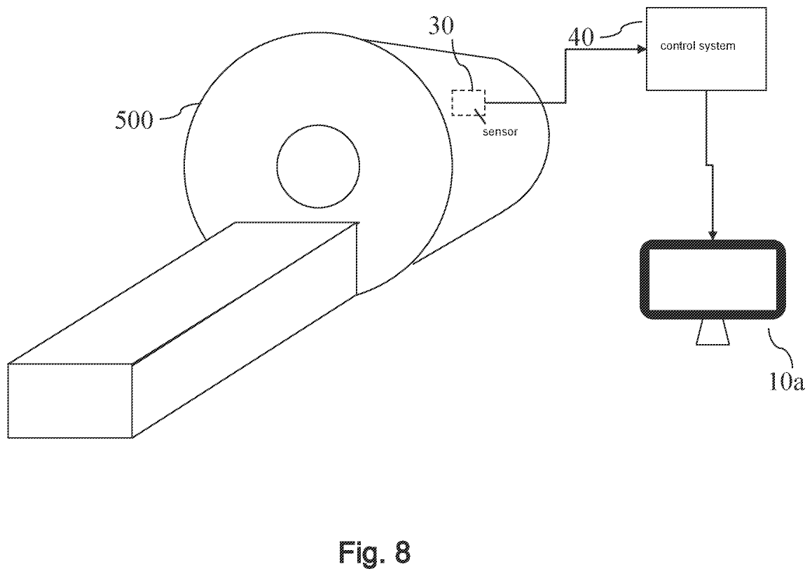

Shown in FIG. 8 is an embodiment of a medical imaging system (500) controlled by the control system (40). The imaging system may, for example, be an MRI apparatus, x-ray imaging apparatus or ultrasonic imaging apparatus. The sensor (30) may, for example, be an imaging sensor which takes at least one image of a patient, e.g., displaying different types of body tissue of the patient.

The classifier (60) may then determine a classification of at least a part of the sensed image. The at least part of the image is hence used as input image (x) to the classifier (60). The classifier (60) may hence be understood as an image classifier.

The control signal (A) may then be chosen in accordance with the classification, thereby controlling a display (10a). For example, the image classifier (60) may be configured to detect different types of tissue in the sensed image, e.g., by classifying the tissue displayed in the image into either malignant or benign tissue. This may be done by means of a semantic segmentation of the input image (x) by the image classifier (60). The control signal (A) may then be determined to cause the display (10a) to display different tissues, e.g., by displaying the input image (x) and coloring different regions of identical tissue types in a same color.

In further embodiments (not shown) the imaging system (500) may be used for non-medical purposes, e.g., to determine material properties of a workpiece. In these embodiments, the image classifier (60) may be configured to receive an input image (x) of at least a part of the workpiece and perform a semantic segmentation of the input image (x), thereby classifying the material properties of the workpiece. The control signal (A) may then be determined to cause the display (10a) to display the input image (x) as well as information about the detected material properties.

The term “computer” may be understood as covering any devices for the processing of pre-defined calculation rules. These calculation rules can be in the form of software, hardware or a mixture of software and hardware.

In general, a plurality can be understood to be indexed, that is, each element of the plurality is assigned a unique index, preferably by assigning consecutive integers to the elements contained in the plurality. Preferably, if a plurality has N elements, wherein N is the number of elements in the plurality, the elements are assigned the integers from 1 to N. It may also be understood that elements of the plurality can be accessed by their index.

What is claimed is:

1. A computer-implemented method for training a normalizing flow, wherein the normalizing flow is configured to determine a first output signal characterizing a likelihood or a log-likelihood of an input signal, wherein the normalizing flow includes at least one first layer, wherein the first layer includes trainable parameters and a layer input to the first layer is based on the input signal and the first output signal is based on a layer output of the first layer, the method comprising the following steps:
determining at least one training input signal;
determining a training output signal for each of the at least one training input signal using the normalizing flow;
determining a first loss value, wherein the first loss value is based on a likelihood or a log-likelihood of the at least one determined training output signal with respect to a predefined probability distribution;
determining an approximation of a gradient of the trainable parameters of the first layer with respect to the first loss value, wherein the gradient is dependent on an inverse of a matrix of the trainable parameters and determining the approximation of the gradient is achieved by optimizing an approximation of the inverse; and
updating the trainable parameters of the first layer based on the approximation of the gradient.

2. The method according to claim 1, wherein the approximation of the inverse is optimized based on the at least one training input signal.
$${z}_{l} = σ ( {h}_{l} ) = σ ( {W}_{l} {z}_{l - 1} ) , {z}_{l} σ {h}_{l} {W}_{l} {z}_{l - 1} {∇}_{{W}_{l}} = \frac{\partial {p}_{X} ( {x}_{i} )}{\partial {h}_{l}} {z}_{l - 1}^{T} + {R}_{l}^{T} , \frac{\partial {p}_{X} ( {x}_{i} )}{\partial {h}_{l}} T {x}_{i} {R}_{l} {W}_{l} 3 .$$

3. The method according to claim 1, wherein the first layer is a fully connected layer and the layer output is determined according to the formula
$${z}_{l} = σ ( {h}_{l} ) = σ ( {W}_{l} {z}_{l - 1} ) , {z}_{l} σ {h}_{l} {W}_{l} {z}_{l - 1} {∇}_{{W}_{l}} = \frac{\partial {p}_{X} ( {x}_{i} )}{\partial {h}_{l}} {z}_{l - 1}^{T} + {R}_{l}^{T} , \frac{\partial {p}_{X} ( {x}_{i} )}{\partial {h}_{l}} T {x}_{i} {R}_{l} {W}_{l}$$
wherein is the layer output of the first layer, is an invertible activation function of the first layer and is a result of a matrix multiplication of a matrix comprising the trainable parameters of the first layer and the layer input, wherein the approximation of the gradient of the first loss value with respect to the trainable parameters is determined according to the formula
$${z}_{l} = σ ( {h}_{l} ) = σ ( {W}_{l} {z}_{l - 1} ) , {z}_{l} σ {h}_{l} {W}_{l} {z}_{l - 1} {∇}_{{W}_{l}} = \frac{\partial {p}_{X} ( {x}_{i} )}{\partial {h}_{l}} {z}_{l - 1}^{T} + {R}_{l}^{T} , \frac{\partial {p}_{X} ( {x}_{i} )}{\partial {h}_{l}} T {x}_{i} {R}_{l} {W}_{l}$$
wherein is a partial derivative of the first loss value with respect to the result of the matrix multiplication, a superscript denotes transposing a matrix or a vector, is the training input signal and is the approximation of the inverse of the matrix.
$${z}_{l} = σ ( {h}_{l} ) = σ ( {W}_{l} {z}_{l - 1} ) , {z}_{l} σ {h}_{l} {W}_{l} {z}_{l - 1} {∇}_{{W}_{l}} = \frac{\partial {p}_{X} ( {x}_{i} )}{\partial {h}_{l}} {z}_{l - 1}^{T} + {R}_{l}^{T} , \frac{\partial {p}_{X} ( {x}_{i} )}{\partial {h}_{l}} T {x}_{i} {R}_{l} {W}_{l} \\ {z}_{l} = σ ( {h}_{l} ) = σ ( {W}_{l} {z}_{l - 1} ) , {z}_{l} σ {h}_{l} {W}_{l} {z}_{l - 1} {∇}_{{W}_{l}} = \frac{\partial {p}_{X} ( {x}_{i} )}{\partial {h}_{l}} {z}_{l - 1}^{T} + {R}_{l}^{T} , \frac{\partial {p}_{X} ( {x}_{i} )}{\partial {h}_{l}} T {x}_{i} {R}_{l} {W}_{l}$$
$${R}_{l} {ℒ}_{recon}^{( l )} = ‖ {R}_{l} {W}_{l} {z}_{l - 1} - {z}_{l - 1} ‖ , ‖ \cdot ‖ 4.$$

4. The method according to claim 3, wherein is determined based on a second loss function Rₗ [symbol] _{recon}^{(l)}=∥RₗWₗzₗ₋₁−zₗ₋₁∥,∥·∥ wherein is a norm.
Rₗ [symbol] _{recon}^{(l)}=∥RₗWₗzₗ₋₁−zₗ₋₁∥,∥·∥
RₗRₗ

5. The method according to claim 4, wherein is determined using an iterative optimization algorithm, the iterative optimization algorithm being a gradient descent algorithm, RₗRₗ wherein only one optimization step is performed for determining.
$${Z}_{l} = σ ( {H}_{l} ) = σ ( {W}_{l} {★Z}_{l - 1} ) , {Z}_{l} σ {H}_{l} {W}_{l} {Z}_{l - 1} ★ {∇}_{{W}_{l}} = \frac{\partial {p}_{X} ( {x}_{i} )}{\partial {H}_{l}} {★Z}_{l - 1} + flip ( {R}_{l} ) ⊙ M , \\ M = ones\_like ( {Z}_{l} ) ★ones\_like ( {Z}_{l - 1} ) , \frac{\partial {p}_{X} ( {x}_{i} )}{\partial {H}_{l}} {x}_{i} ⊙ ones\_like {R}_{l} {H}_{l} {Z}_{l - 1} flip 6.$$

6. The method according to claim 1, wherein the first layer is a convolutional layer and the layer output is determined according to the formula
$${Z}_{l} = σ ( {H}_{l} ) = σ ( {W}_{l} {★Z}_{l - 1} ) , {Z}_{l} σ {H}_{l} {W}_{l} {Z}_{l - 1} ★ {∇}_{{W}_{l}} = \frac{\partial {p}_{X} ( {x}_{i} )}{\partial {H}_{l}} {★Z}_{l - 1} + flip ( {R}_{l} ) ⊙ M , \\ M = ones\_like ( {Z}_{l} ) ⋆ ones\_like ( {Z}_{l - 1} ) , \frac{\partial {p}_{X} ( {x}_{i} )}{\partial {H}_{l}} {x}_{i} ⊙ ones\_like {R}_{l} {H}_{l} {Z}_{l - 1 } flip$$
wherein is the layer output of the first layer, is an invertible activation function of the first layer, is a result of a discrete convolution of a tensor comprising the trainable parameters of the first layer and the layer input and denotes a discrete convolution operation, wherein the gradient of the first loss value with respect to the trainable parameters is determined according to the formula
$${Z}_{l} = σ ( {H}_{l} ) = σ ( {W}_{l} {★Z}_{l - 1} ) , {Z}_{l} σ {H}_{l} {W}_{l} {Z}_{l - 1} ★ {∇}_{{W}_{l}} = \frac{\partial {p}_{X} ( {x}_{i} )}{\partial {H}_{l}} {★Z}_{l - 1} + flip ( {R}_{l} ) ⊙ M , \\ M = ones\_like ( {Z}_{l} ) ⋆ ones\_like ( {Z}_{l - 1} ) , \frac{\partial {p}_{X} ( {x}_{i} )}{\partial {H}_{l}} {x}_{i} ⊙ ones\_like {R}_{l} {H}_{l} {Z}_{l - 1 } flip$$
wherein is a partial derivative of the first loss value with respect to the result of the discrete convolution, is the training input signal, denotes an element-wise multiplication operation, is a function that takes a first tensor as input and returns a second tensor of the same shape as the first tensor, wherein the second tensor is filled with all ones, and is a tensor characterizing an approximation of a third tensor, wherein convolving the third tensor with yields, and is a function that determines a tensor for a transpose convolution.
$${Z}_{l} = σ ( {H}_{l} ) = σ ( {W}_{l} {★Z}_{l - 1} ) , {Z}_{l} σ {H}_{l} {W}_{l} {Z}_{l - 1} ★ {∇}_{{W}_{l}} = \frac{\partial {p}_{X} ( {x}_{i} )}{\partial {H}_{l}} {★Z}_{l - 1} + flip ( {R}_{l} ) ⊙ M , \\ M = ones\_like ( {Z}_{l} ) ★ones\_like ( {Z}_{l - 1} ) , \frac{\partial {p}_{X} ( {x}_{i} )}{\partial {H}_{l}} {x}_{i} ⊙ ones\_like {R}_{l} {H}_{l} {Z}_{l - 1} flip$$
$${Z}_{l} = σ ( {H}_{l} ) = σ ( {W}_{l} {★Z}_{l - 1} ) , {Z}_{l} σ {H}_{l} {W}_{l} {Z}_{l - 1} ★ {∇}_{{W}_{l}} = \frac{\partial {p}_{X} ( {x}_{i} )}{\partial {H}_{l}} {★Z}_{l - 1} + flip ( {R}_{l} ) ⊙ M , \\ M = ones\_like ( {Z}_{l} ) ★ones\_like ( {Z}_{l - 1} ) , \frac{\partial {p}_{X} ( {x}_{i} )}{\partial {H}_{l}} {x}_{i} ⊙ ones\_like {R}_{l} {H}_{l} {Z}_{l - 1} flip$$
$${Z}_{l} = σ ( {H}_{l} ) = σ ( {W}_{l} {★Z}_{l - 1} ) , {Z}_{l} σ {H}_{l} {W}_{l} {Z}_{l - 1} ★ {∇}_{{W}_{l}} = \frac{\partial {p}_{X} ( {x}_{i} )}{\partial {H}_{l}} {★Z}_{l - 1} + flip ( {R}_{l} ) ⊙ M , \\ M = ones\_like ( {Z}_{l} ) ★ones\_like ( {Z}_{l - 1} ) , \frac{\partial {p}_{X} ( {x}_{i} )}{\partial {H}_{l}} {x}_{i} ⊙ ones\_like {R}_{l} {H}_{l} {Z}_{l - 1} flip$$
$${R}_{l} {ℒ}_{recon}^{( l )} = ‖ {R}_{l} ⋆ {W}_{l} ⋆ {Z}_{l - 1} - {Z}_{l - 1} ‖ , ‖ \cdot ‖ 7.$$

7. The method according to claim 6, wherein is determined based on a second loss function Rₗ [symbol] _{recon}^{(l)}=∥Rₗ*Wₗ*Zₗ₋₁−zₗ₋₁∥,∥·∥ wherein is a norm.
Rₗ [symbol] _{recon}^{(l)}=∥Rₗ*Wₗ*Zₗ₋₁−Zₗ₋₁∥,∥·∥

8. The method according to claim 7, wherein Rₗ is determined using an iterative optimization algorithm, the iterative optimization algorithm being a gradient descent algorithm, wherein only one optimization step is performed for determining Rₗ.

9. The method according to claim 1, wherein a device is operated in accordance with the output signal of the normalizing flow.

10. The method according to claim 1, wherein the normalizing flow is comprised in a classifier, wherein the classifier is configured to determine a second output signal characterizing a classification of the input signal, wherein the second output signal is determined based on the first output signal.

11. The method according to claim 1, wherein the input signal characterizes an internal state of a device and/or an operation status of the device and/or a state of an environment of the device, and wherein information comprised in the first output signal of the normalizing flow is made available to a user of the device by means of a displaying device.

12. A training system configured to train a normalizing flow, wherein the normalizing flow is configured to determine a first output signal characterizing a likelihood or a log-likelihood of an input signal, wherein the normalizing flow includes at least one first layer, wherein the first layer includes trainable parameters and a layer input to the first layer is based on the input signal and the first output signal is based on a layer output of the first layer, the training system configured to:
determine at least one training input signal;
determine a training output signal for each of the at least one training input signal using the normalizing flow;
determine a first loss value, wherein the first loss value is based on a likelihood or a log-likelihood of the at least one determined training output signal with respect to a predefined probability distribution;
determine an approximation of a gradient of the trainable parameters of the first layer with respect to the first loss value, wherein the gradient is dependent on an inverse of a matrix of the trainable parameters and determining the approximation of the gradient is achieved by optimizing an approximation of the inverse; and
update the trainable parameters of the first layer based on the approximation of the gradient.

13. A non-transitory machine-readable storage medium on which is stored a computer program for training a normalizing flow, wherein the normalizing flow is configured to determine a first output signal characterizing a likelihood or a log-likelihood of an input signal, wherein the normalizing flow includes at least one first layer, wherein the first layer includes trainable parameters and a layer input to the first layer is based on the input signal and the first output signal is based on a layer output of the first layer, the computer program, when executed by a computer, causing the computer to perform the following steps:
determining at least one training input signal;
determining a training output signal for each of the at least one training input signal using the normalizing flow;
determining a first loss value, wherein the first loss value is based on a likelihood or a log-likelihood of the at least one determined training output signal with respect to a predefined probability distribution;
determining an approximation of a gradient of the trainable parameters of the first layer with respect to the first loss value, wherein the gradient is dependent on an inverse of a matrix of the trainable parameters and determining the approximation of the gradient is achieved by optimizing an approximation of the inverse; and
updating the trainable parameters of the first layer based on the approximation of the gradient.
